(19) United States
(12) Patent Application Publication
(10) Pub. No.: US 2025/0061472 A1
(43) Pub. Date: Feb. 20, 2025

(54) Dynamic Condensing of Digital Content with Insertion of Expansion Elements

(71) Applicant: International Business Machines Corporation, Armonk, NY (US)

(72) Inventors: Namit Kabra, Hyderabad (IN); Sarbajit K. Rakshit, Kolkata (IN); Vijay Ekambaram, Chennai (IN)

(21) Appl. No.: 18/234,577

(22) Filed: Aug. 16, 2023

(51) Int. Cl. G06Q 30/0201; G06N 20/00

(52) U.S. Cl. CPC G06Q 30/0201; G06N 20/00

(57) ABSTRACT

Mechanisms are provided for rendering content in a compacted view. A machine learning computer model is trained by a machine learning process to predict a user attention score for segments of content based on features of the content and historical user attention data. The trained machine learning computer model processes new content to associate with each segment, in a plurality of segments, of the new content, a corresponding user attention score. The segments, in the plurality of segments, of the new content are ranked relative to one another based on the corresponding user attention scores of the segments. A compacted view of the new content is rendered based on the ranking of the segments. A first number of segments are rendered in the compacted view and a second number of segments are not rendered in the compacted view, and are replaced with an inserted user selectable expansion element.

### BACKGROUND

The present application relates generally to an improved data processing apparatus and method and more specifically to an improved computing tool and improved computing tool operations/functionality for dynamic condensing of digital content and insertion of expansion elements for expanding the condensed digital content.

Viewing of digital content, e.g., textual content of various electronic documents, is a daily occurrence especially with regard to online activity. Reading news articles, entertainment articles, electronic magazines, books, newspapers, and the like, via websites, newsfeeds, and other electronic sources is often a part of a person's daily activities. Such textual content is vastly growing, and users often must comb through a large volume of textual content to find the content that is of interest to them. Various user interface mechanisms have been devised to assist users in navigating such content, however these mechanisms tend to be fixed and manually inserted by the content creators.

Users having to navigate large quantities of textual content to identify the content they wish to consume will be even more of an issue as the steady advancement in virtual and augmented reality continues. That is, as more users utilize VR/AR equipment, such as Google Cardboard®, Oculus Go®, and Samsung GearVR®, and other VR/AR software applications executable on client devices, smartphones, and the like, which is becoming more affordable, content providers will attempt to capture the attention of the users in the virtual environment. Newsfeeds and other content streaming services will compete for user attention through virtual environment interfaces similar to the way that they compete today on more conventional computing system displays.

For example, in modern VR environments, textual readers, such as ImmersionVR Reader, Chimera Reader, and the like, have been developed to allow users to view textual content in a readable format within a virtual reality environment. The goal of these applications is to replicate the reading experience of physical books and comics, and existing e-readers, by introducing similar formatting and navigation in a virtual reality environment. However, it can be seen that such textual readers may soon be utilized to present content, such as newsfeeds, entertainment articles, educational materials, and the like, in a virtual environment setting.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for rendering content in a compacted view. The method comprises training, through a machine learning process, a machine learning computer model to predict a user attention score for segments of content based on features of the content and historical user attention data. The method further comprises processing, by the trained machine learning computer model, new content to associate with each segment, in a plurality of segments, of the new content, a corresponding user attention score. The method also comprises ranking the segments, in the plurality of segments, of the new content relative to one another based on the corresponding user attention scores of the segments. In addition, the method comprises rendering a compacted view of the new content on a client computing system based on the ranking of the segments. A first number of segments are rendered in the compacted view and a second number of segments are not rendered in the compacted view and are replaced with an inserted user selectable expansion element.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram illustrating a “see more” tag in textual content;

FIG. 1B is an example diagram illustrating a multi-fold “see more” tag in textual content in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example diagram illustrating the primary operational components of a dynamic content compaction and expansion element insertion engine in accordance with one illustrative embodiment;

FIG. 4 is a flowchart outlining an example operation for preparing training data for training a machine learning computer model of the dynamic content compaction and expansion element insertion engine in accordance with one illustrative embodiment;

FIG. 5 is a flowchart outlining an example operation for training a machine learning computer model and deploying the trained machine learning computer model in accordance with one illustrative embodiment; and

FIG. 6 is a flowchart outlining an example operation for generating a textual summary with expansion element insertion based on a trained machine learning computer model operation in accordance with one illustrative embodiment.

### DETAILED DESCRIPTION

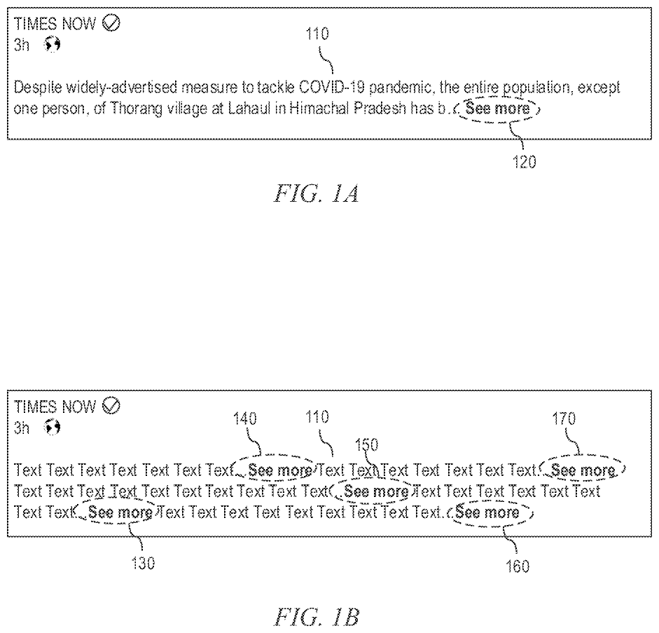

As content providers are competing for viewable space on computing screens so as to capture the attention of users, content portals often utilize tools, such as the “see more” mechanism, to minimize content to a summary of the content with a user selectable “see more” element, referred to herein as a “see more” tag, that the user can click or otherwise select in order to see the obfuscated portions of the content. FIG. 1A is one example of a portion of textual content in which a “see more” tag is provided to shorten the textual content. As is shown in FIG. 1A, the textual content comprises a portion of the text 110 with a “see more” user selectable element 120 that is appended to the displayed text, and which is used to access the portion of the textual content that is not displayed initially, i.e., the compacted or obfuscated text. A user may view the displayed portion of the text 110 to see what the textual content is likely to contain and determine whether the user wishes to “see more” of the textual content. The user may then select the “see more” tag 120 in order to have the display content updated so as to present the portion of textual content that was not previously displayed. This mechanism allows a content provider portal to compact the textual content for conserving display area, thereby allowing a larger amount of content from the same or different content providers to be provided through the same portal at substantially the same time.

This “see more” tagging mechanism is often utilized in situations such as web pages, web portals, online news portals, and the like, where multiple different portions of textual content are to be presented to a user via the same web page. For example, many news organizations have web pages where multiple news articles are presented on the same web page with only headlines or small portions of the news article being shown and the remainder of the news article being represented by a “see more” tag that the user can click in order to be presented with the entire news article. That is, the “see more” tag is implemented as a user interface element that compacts the textual content such that only when the user clicks on the “see more” tag is the full content expanded and viewable via the display. In some cases, the “see more” tag may even be a hyperlink that redirects the user's browser to another web page entirely where the full content can be presented.

The current utilization of the “see more” tagging mechanism is fixed and manually inserted into the textual content such that a first portion of the textual content 110 is displayed, but then the remainder of the textual content is obfuscated and only accessible if the user clicks on or selects the “see more” tag 120. This means that the location of the “see more” tags and the associations of the “see more” tags with textual content is the same for each user based on the a priori specification by the textual content provider. In some cases, some rudimentary rules may be provided, such as “any content after x words get wrapped inside see_more tag”, but these rules are again fixed and have no relation to user behaviors and input patterns. That is, the current implementation of “see more” tags are not able to adapt to the specific context and content being presented. Static “see more” tags are predefined and placed at specific predetermined locations in the content, providing a fixed amount of additional information or interaction.

The illustrative embodiments provide an improved computing tool and improved computing tool operations/functionality for automatically and dynamically determining locations of “see more” tag elements, or more generally referred to as expansion elements, in computer rendered content based on an analysis by a trained machine learning computer model. Put another way, the illustrative embodiments dynamically identify which portions of computer rendered content should be compacted into a “see more” tag element, where such determination is based at least on some behavioral factors of users. Such dynamic identification of where to place the expansion elements, or “see more” tags, can operate on real-time analysis and understanding of the content, user's behavior, and other contextual factors. This provides a distinct advantage over existing fixed or static “see more” tag mechanisms in that the illustrative embodiments provide adaptability, relevance, flexibility, real-time updates, and improved user engagement.

In some illustrative embodiments, the trained machine learning computer model may be trained based on historical data from a plurality of different users gathered over a period of time for a plurality of different pieces of content, e.g., textual content. The trained machine learning computer model can also, or alternatively, be tailored to an individual user by training, or re-training, the machine learning computer model based on training data gathered for the particular user. In both cases, the training data that is gathered may include eye gaze data specifying where a user's eye focuses when viewing training content, and user click stream data specifying where the user clicks, via a user interface device, when viewing the training content, e.g., what portions of textual content the user's eye views and spends most of its time viewing, and what portions of the textual content does the user click on when viewing the content, e.g., which “see more” tags, the user clicks on.

The training data gathered from the user(s) is used along with features extracted from the training content, to train a machine learning computer model to predict the portions of content where a user's eye gaze will likely fall and locations within the content where “see more” tags will likely be used by the user to view additional portions of the displayed content. That is, based on the historical behavior of the user(s) on training content with regard to eye gaze and clicks, the machine learning computer model learns an association between the features of the content, e.g., layout and format features of the content, with eye gaze and user clicks. Thereafter, once trained, the machine learning computer model may be presented with input comprising features extracted from new content to be presented to a user, and can predict where in the content the user's gaze is likely to fall and where the user would likely click on the content to access additional portions of the content, such as via a “see more” tag positioned at the predicted click locations. These features may also include content provider specified recommended locations for “see more” tags which may be considered, by where such recommended locations may not be the final locations of the “see more” tags when all factors are evaluated by the machine learning computer model(s).

It should be appreciated that the machine learning computer model may operate to insert multi-fold “see more” tags into the new content based on the prediction of eye gaze and click locations. That is, given a portion of content, “see more” tags may be associated with areas where the user's gaze is not predicted to be present as much, but where the user is more likely to click on the “see more” tag if the user wishes to access the additional compacted or obfuscated portion of content. This may include multiple different locations within the content, such as shown in FIG. 1B. That is, as shown in FIG. 1B, based on the predicted eye gaze and click locations made by the trained machine learning computer model of the illustrative embodiments, it is determined that multiple different portions of the textual content can be compacted/collapsed into a “see more” tag 130-170 in order to minimize the space requirement of the initial display of the content. These “see more” tags 130-170 may be associated with portions of content that are ranked relatively lower than other portions of content with regard to eye gaze and click location, as discussed in greater detail hereafter.

As noted above, some of the features of the content that may be used as input to train the machine learning computer model and to generate predictions for new content include the layer and format of the content itself. In addition to the features of the content, such as structural features including layout and format, the training data may further include features specifying the type of content represented and user profile information may be used to identify preferences for various types of content. For example, a user may specify what types of content they prefer to view and/or what types of content that they may not wish to view in their entirety on a regular basis. This information may be specified by the user when establishing a profile and/or may be gathered automatically based on user historical input, e.g., user “likes”, user request to “see less” of a particular type of content, and the like. For those types of content that the user wishes to view, fewer “see more” tags may be inserted into the content. For those types of content that the user wishes to see less of, more “see more” tags may be inserted. This may be further implemented by the use of the ranking of portions of content and a threshold for which the top ranked portions are rendered, e.g., top K ranked sentences in textual content may be rendered in the initial display of the content, where K may be set based on an evaluation of whether the user wishes to see more or less of that particular type of content as indicated in their user profile.

Moreover, it is recognized herein, with regard to virtual reality and augmented reality environments, that functionality may be made available to not only utilize such “see more” tagging to compact the representation of textual content, or even images associated with textual content, in virtual reality/augmented reality environments, but also to extend such compaction to virtual reality and augmented reality objects within the virtual reality/augmented reality (VR/AR) environment. For example, objects with which the user may not have shown an interest in the past may be replaced with a user selectable indicator, e.g., a VR/AR “see more” tag element, such that the user is not presented with objects that are of no interest to the user. As an example, VR/AR signs, billboards, advertisements, and the like, may be replaced with the “see more” tag element in accordance with one or more of the illustrative embodiments as described hereafter. Thus, while the description of the illustrative embodiments will primarily focus on textual content as examples, as these may be easier for those of ordinary skill in the art to understand, the mechanisms of the illustrative embodiments may be applied to any type of computer rendered content which may be compacted/collapsed into a “see more” tag element without departing from the spirit and scope of the present invention.

In addition, while the tag element is described herein as a “see more” tag, the illustrative embodiments are not limited to any particular text indicator, graphical representation, or selectable user interface element. To the contrary, the inserted expansion elements, a “see more” tag being only one example, may take many different forms and have different textual and graphical representations without departing from the spirit and scope of the present invention. For example, the “see more” tag may not include the text “see more” and instead may be merely a graphical element or may have different text, e.g., “more?”, designating a user selectable element for accessing additional obfuscated portions of the content. Thus, hereafter, these elements will be referred to herein as expansion elements.

Thus, with the mechanisms of the illustrative embodiments, improved computing tools and improved computing tool operations/functionality are provided to automatically and dynamically customize the location of expansion elements, and thus, the corresponding portions of computer rendered content to compact, based on historical user behavior both with regard to a plurality of different users and/or with a particular user. This historical behavior may include historical eye gaze information and historical click stream data. In this way, the expansion element placement in content may be customized to the particular user(s) based on past behavior. Moreover, the placement of expansion elements in content may be made so as to maximize the likelihood that the user(s) will select the expansion element if they are interested in viewing the compacted portion of content, i.e., the obfuscated portions of content, while still being able to minimize the space requirements for rendering the content.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a dynamic content compaction and expansion element insertion engine 300. The improved computing tool implements mechanism and functionality, such as the dynamic content compaction and expansion element insertion engine 300 which cannot be practically performed by human beings either outside of, or with the assistance of, a technical environment, such as a mental process or the like. The improved computing tool provides a practical application of the methodology at least in that the improved computing tool is able to automatically learn optimum compaction of portions of computer rendered content and replacement with inserted expansion elements so as to make the rendering of the content more efficient and user navigable while maximizing the use of displayable regions.

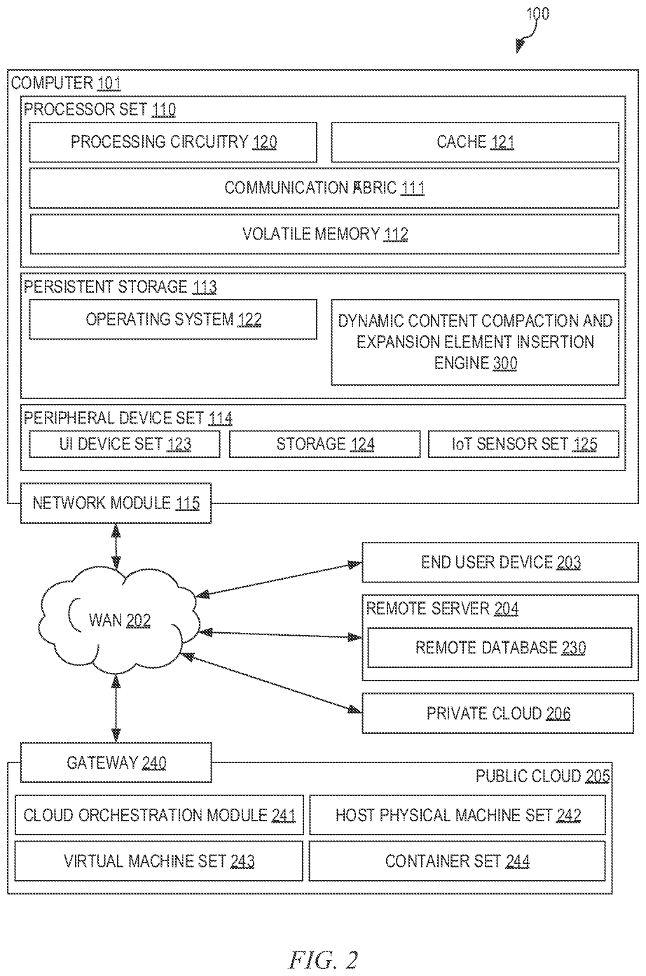

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as dynamic content compaction and expansion element insertion engine 300. In addition to dynamic content compaction and expansion element insertion engine 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and dynamic content compaction and expansion element insertion engine 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in dynamic content compaction and expansion element insertion engine 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in dynamic content compaction and expansion element insertion engine 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a dynamic content compaction and expansion element insertion engine 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates dynamic content compaction and expansion element insertion.

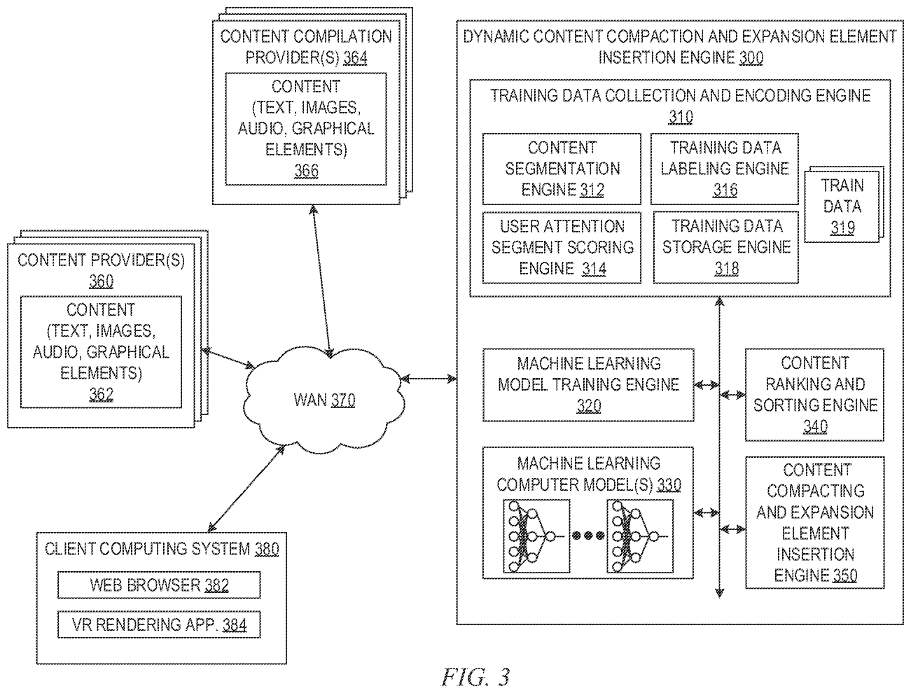

FIG. 3 is an example diagram illustrating the primary operational components of a dynamic content compaction and expansion element insertion engine in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatic operation of the dynamic content compaction and expansion element insertion engine to improving the way that digital content rendering is performed so as to optimize rendering of content within a given displayable region so as to maximize the amount of different content displayed and minimize the difficulty in users accessing the compacted or obfuscated content if desired. Such operations are performed automatically and dynamically as digital content is to be displayed, with such functionality not being able to be practically performed dynamically by human beings as a mental process and is not directed to organizing any human activity.

In some illustrative embodiments, the dynamic content compaction and expansion element insertion engine 300 in FIG. 3 may be implemented as a service provided by one or more server computing devices. As such, the service may be invoked by client computing devices 380, or content provider computing systems 360 or content compilation computing systems 364, to determine how to dynamically compact content, e.g., content 362 or 366, and insert expansion elements for efficient rendering of summarized content. The content itself may comprise any text, images, audio, graphical elements, or the like, which may each be compacted and have corresponding inserted expansion elements inserted.

Content provider computing systems 360 are computing systems that provide the actual content to be rendered on client computing devices via content rendering application(s). These content provider computing systems 360 may be any source of digital content, such as websites, digital publishers, or the like, that provide their own digital content to end users. Content compilation computing systems 364 are computing systems that compile content from content providers and provide the compiled content to rendering applications of client computing devices for presentation. Examples of content compilation computing systems 364 may include social networking computing systems, gaming services, digital music services, news feed services, podcast services, etc., where these content compilation computing systems 3645 act as intermediaries for users by performing the operations to collect the content from a variety of different content providers and then providing a one-stop shopping place for users to access various content from various content providers.

In some illustrative embodiments, the dynamic content compaction and expansion element insertion engine 300 in FIG. 3 may be implemented as a plug-in to a content rendering application, such as a web browser 382, virtual reality (VR) rendering application 384, augmented reality (AR) rendering application, or other content rendering application, or as a separate application executed on one or more client computing devices, content provider computing devices, or content compilation computing systems. In such cases where the engine 300 is implemented on the client computing devices 380 themselves, the content provider computing systems 360 and/or content compilation provider computing systems 364 may provide their corresponding content 362, 366 to the client computing system 380 via one or more data networks, such as wide area network (WAN) 370. In response to receiving the content, the client computing system 380 processes the content 362, 366 via the engine 300 implemented on the client computing device 380 before rendering the content on the output devices, e.g., display, audio output device, and/or the like.

As shown in FIG. 3, the dynamic content compaction and expansion element insertion engine 300 includes a training data collection and encoding engine 310, a machine learning model training engine 320, one or more machine learning computer models 330, content ranking and sorting engine 340, and content compacting and expansion element insertion engine 350. The training data collection engine 310 comprises a content segmentation engine 312, a user attention segment scoring engine 314, a training data labeling engine 316, and a training data storage engine 318. The machine learning model training engine 320 comprises logic for performing machine learning training operations, e.g., linear regression, node weight modification, loss determinations, etc., for training the one or more machine learning computer models 330. The machine learning computer model(s) 330 may comprise neural networks or other machine learning computer model(s) that may be trained through a machine learning process based on the labeled training data generated by the training data collection and encoding engine 310. The machine learning computer model(s)s 330 are trained to receive input factors extracted from input content, identify patterns in the input factors, and correlate those patterns with one or more predictions of locations of user attention in the input content, such as in the form of a heat map or the like.

The output of the machine learning computer model(s) 330 may be input to the content ranking and sorting engine 340. The content ranking and sorting engine 340 comprises logic to score the content with regard to user attention and candidate locations for compaction of portions of the content and insertion of expansion elements. For example, the heat map prediction may indicate levels of user attention with regard to portions of the content and these predictions of levels of user attention may then be converted to scores on a predetermined scale. The scores for the various portions of the content may be input to the content compacting and expansion element insertion engine 350 which selects one or more of the various portions, based on the scores, for compaction and insertion of an expansion element, to thereby generate modified digital content for presentation. The modified digital content is then presented to one or more users via one or more digital content rendering applications, e.g., web browsers 382, VR rendering applications 384, or the like, executing on one or more client computing devices 380.

As noted above, the illustrative embodiments provide an improved computing tool and improved computing tool operations/functionality for automatically and dynamically determining locations of expansion elements, such as “see more” tag elements, in computer rendered content based on an analysis by trained machine learning computer models. In some illustrative embodiments, the trained machine learning computer model may be trained based on historical data from a plurality of different users gathered over a period of time for a plurality of different pieces of content, e.g., textual content, audio content, graphical element content, images, and the like. That is, the training data collection and encoding engine 310 of the dynamic content compaction and expansion element insertion engine 300 may collect data from client computing systems 380 viewing the same content to gather information about where the users of the client computing systems 380 focus their eye gaze and/or perform click stream operations. This may be performed over a plurality of different content such that data for each content may be collected for a plurality of users, i.e., there are one or more data structures for each portion of digital content, where these one or more data structures each store data specifying the eye gaze locations and/or click stream locations for one or more users.

The training data collection and encoding engine 310 may perform content segmentation by the content segmentation engine 312. For example, natural language processing, image recognition, audio file identification, and other analysis may be performed on the content to identify portions of the text, e.g., sentences, phrases, terms, and the like, portions of the content that comprise images, portions of the content that comprise audio file links, and the like. Each of these portions may be considered separate segments of the content and may be labeled as to the type of content present in those segments by the training data labeling engine 316. Moreover, the content segmentation engine 312 may comprise eye gaze tracking logic and/or click stream tracking logic which monitors where the user's eye gaze falls within the displayed content, and/or where the user clicks with their computer mouse or other user interface device while viewing the displayed content. Eye gaze may require virtual reality and/or augmented reality equipment and software on the client computing systems 380 in order to track eye gaze using cameras or the like. As noted above, the mechanisms of the illustrative embodiments may be implemented with VR/AR systems when compressing content and inserting corresponding expansion elements in VR/AR environments.

The eye gaze data and click stream data collected over a plurality of users over a period of time, for the same portion of content, may be used to generate a heat map data structure that presents a heat map that may be overlayed on the locations of the segmented content to identify which segments the user's attention is primarily directed to. This heat map correlation with the segments may be performed by the user attention segment scoring engine 314 to thereby score the various segments based on the amount of user attention directed to the various segments. For example, each segment may be scored on a predetermined scale, e.g., 0 to 1, where on extreme represents a relatively largest amount of user attention (e.g., 1), and the other extreme of the scale represents a relatively smallest or no user attention (e.g., 0). The training data labeling engine 316 may further label the segments of the content with corresponding score labels.

For example, assuming the segments of content comprise sentences in textual content, natural language processing and encoding may be performed to segment the textual content into sentences and embed those sentences into vector representations, such as using a bidirectional encoder representation from transformers (BERT) model and tokenizer, where this encoding and tokenizer captures semantic meaning of the sentences while illuminating syntactic features. Each of the sentences have locations within the format and layout of the content when it is displayed to the user. These locations may be correlated with user clicks and/or eye gaze via the heat map mechanisms mentioned above. Thus, the sentences may then be scored based on user attention determinations based on the heat map correlated with the sentences. A scoring function is defined that correlates user attention with regard to eye gaze instances, eye gaze time, clicks, and the like, to a numerical score on a predetermined scale, e.g., 0 to 1. Thus, each sentence has a corresponding user attention score from 0 to 1 based on how much a user views or interacts with the corresponding sentence with the content is displayed or otherwise output to the user. This can be done for various types of content and is not limited to textual content.

In some illustrative embodiments, the labeled training data is compiled across a plurality of portions of content and a plurality of users. In other illustrative embodiments, the labeled training data may be specific to a particular user alternatively, or in addition to, the plurality of users. That is, the training data may, in some illustrative embodiments, represent the user attention behaviors of a particular user with regard to various content and thus, may be labeled based on that particular user's attention as indicated by that user's eye gaze and/or click stream. In this way, the trained machine learning computer model(s) 330 can also, or alternatively, be tailored to an individual user by training, or re-training, the machine learning computer model(s) 330 based on training data gathered for the particular user. In either case, the training data may be stored by the training data storage engine 318 in one or more training datasets 319. The labels associated with the training data may serve as ground truth data for performing machine learning training of machine learning computer models.

That is, the training data 319 gathered from the user(s) is used by the machine learning model training engine 320 along with features extracted from the training content itself, e.g., format and layout structure information specifying locations of portions of content, to train one or more machine learning computer models 330 to predict the portions of content where a user's eye gaze will likely fall and locations within the content where expansion elements, e.g., “see more” tags, will likely be used by the user to view additional portions of the displayed content, e.g., compacted or obfuscated portions of content. That is, based on the historical behavior of the user(s) as represented in the training data 319, the machine learning computer model(s) 330 learn an association between the features of the content, e.g., layout and format features of the content, with eye gaze and user clicks, i.e., user attention. The machine learning training performed by the machine learning model training engine 320 may comprise inputting features of the training data 319, executing the machine learning model 330 on these features to generate a prediction/classification with regard to user attention of various portions of the content, e.g., user attention scoring of the various portions of content, and then comparing those user attention scores with the labels of the training data 319. The error or loss determined from the comparison may then be used to drive modifications to the machine learning computer model 330, e.g., weights of nodes or the like, so as to minimize the error or loss. In this way, the machine learning computer model(s) 330 learn an association between patterns of input features and user attention scores for portions of content and thus, learns how to predict user attention scores for portions of content.

Thereafter, once trained, the machine learning computer model(s) 330 may be presented with input comprising features extracted from new content to be presented to a user, and can predict user attention scores for portions of the new content. The predicted user attention scores indicate where in the content the user's gaze is likely to fall and where the user would likely click on the content to access additional portions of the content, such as via an expansion element, e.g., “see more” tag, positioned at the various locations within the new content. The resulting user attention scores for portions of the new content, e.g., sentences in textual content, may be provided to the content ranking and sorting engine 340 along with other features of the content, such as the type of content represented, content provider specified preferred locations of expansion elements, and user profile information. This information may be used to identify preferences for various types of content. For example, a user may specify what types of content they prefer to view and/or what types of content that they may not wish to view in their entirety on a regular basis. This information may be specified by the user when establishing a profile and/or may be gathered automatically based on user historical input, e.g., user “likes”, user request to “see less” of a particular type of content, and the like. For those types of content that the user wishes to view, fewer “see more” tags may be inserted into the content. For those types of content that the user wishes to see less of, more “see more” tags may be inserted.

The content ranking and sorting engine 340 may then evaluate each of the user attention scoring by the machine learning model(s) 330, the user profile information, the content types, the content provider specified preferred locations of expansion elements, and the like, to determine a score for each of the portions of the new content, again this may be along a predetermined scale. For example, a weighted function of each of these factors may be used, with weights being assigned by a system administrator, the user, or the like, to generate a final score for each of the portions of content, e.g., sentences, with regard to where compacting of portions of content and insertion of associated expansion elements should be performed. The content ranking and sorting engine 340 may then rank the portions of content relative to one another and select a predetermined number of these portions of content for presentation in a rendering of the content and/or for compaction and insertion of expansion elements. For example, a threshold for which the top ranked portions are rendered, e.g., top K ranked sentences in textual content may be rendered in the initial display of the content, where K may be set based on an evaluation of whether the user wishes to see more or less of that particular type of content as indicated in their user profile. Alternatively, a K number of the lowest ranked portions of content may be selected for compaction and insertion of expansion elements.

The identification of portions of the new content to render and portions of the new content to compact and represent with expansion elements may be provided to the content compacting and expansion element insertion engine 350. The content compacting and expansion element insertion engine 350 comprises the logic for modifying the content to specify portions to be rendered and portions to be compacted along with the insertion of expansion elements at the various locations of these portions of content. The modified content may then be presented to the content rendering applications, e.g., the web browser 382, the VR rendering application 384, or the like, at the client computing system 380. Thereafter, if the user of the client computing system 380 selects an expansion element in the rendered content, the compacted portion of content may be automatically rendered for perceiving by the user.

As noted above, it should be appreciated that the machine learning computer model(s) 330 and the content ranking and sorting engine 340 and content compacting and expansion element insertion engine 350 may operate to insert multi-fold expansion elements, e.g., “see more” tags, into the new content based on the prediction of eye gaze and click locations, i.e., user attention scores, and other evaluated factors from the user profile information and the like. That is, given a portion of content, expansion elements may be associated with areas where the user's gaze is not predicted to be present as much, but where the user is more likely to click on the expansion element if the user wishes to access the additional compacted or obfuscated portion of content. This may include multiple different locations within the content.

With regard to virtual reality (VR) and augmented reality (AR) environments, rendered to the user via VR and/or AR equipment and software at the client computing system 380, that functionality may be made available to not only utilize such expansion elements to compact the representation of textual content, images associated with textual content, audio data sources, and the like, in VR/AR environments, but also to extend such compaction to VR/AR objects within the VR/AR environment. For example, objects with which the user may not have shown an interest in the past, as represented by previously collected data of eye gaze and click streams, may be replaced with a user selectable indicator, e.g., a VR/AR “see more” tag element, such that the user is not presented with objects that are of no interest to the user. As an example, VR/AR signs, billboards, advertisements, and the like, may be replaced with the “see more” tag element in accordance with one or more of the illustrative embodiments as described hereafter. Thus, the illustrative embodiments may be applied to any type of computer rendered content which may be compacted/collapsed into an expansion element, e.g., “see more” tag element, without departing from the spirit and scope of the present invention.

Thus, with the mechanisms of the illustrative embodiments, improved computing tools and improved computing tool operations/functionality are provided to automatically and dynamically customize the location of expansion elements, and thus, the corresponding portions of computer rendered content to compact, based on historical user behavior both with regard to a plurality of different users and/or with a particular user. This historical behavior may include historical eye gaze information and historical click stream data. In this way, the expansion element placement in content may be customized to the particular user(s) based on past behavior. Moreover, the placement of expansion elements in content may be made so as to maximize the likelihood that the user(s) will select the expansion element if they are interested in viewing the compacted portion of content, i.e., the obfuscated portions of content, while still being able to minimize the space requirements for rendering the content.

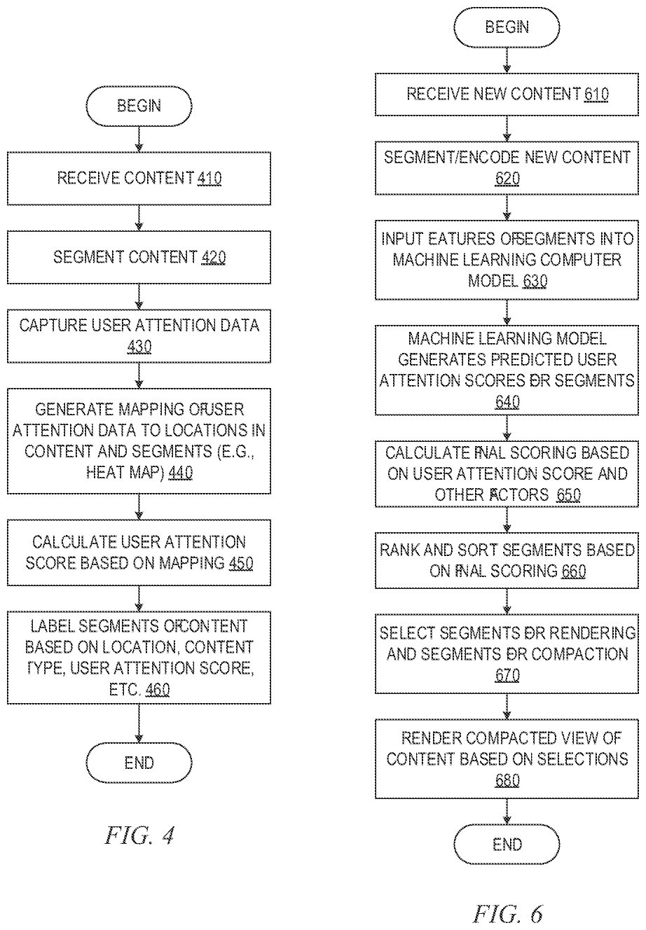

FIGS. 4-6 present flowcharts outlining example operations of elements of the present invention with regard to one or more illustrative embodiments. It should be appreciated that the operations outlined in FIGS. 4-6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-6, and may, in some cases, make use of the results generated as a consequence of the operations set forth in FIGS. 4-6, the operations in FIGS. 4-6 themselves are specifically performed by the improved computing tool in an automated manner.

FIG. 4 is a flowchart outlining an example operation for preparing training data for training a machine learning computer model of the dynamic content compaction and expansion element insertion engine in accordance with one illustrative embodiment. As shown in FIG. 4, the operation starts by receiving content (step 410). The content is segmented into a plurality of segments using natural language processing, encoding models, image analysis, or any other application for identifying different types of content and portions within each type of content, e.g., sentence tokenization and/or the like, in textual content (step 420). The segmenting of the content may include encoding the segments of the content using one or more encoding models, such as a BERT model for textual content, and the like.

User attention data is captured for the received content (step 430) where this user attention data may include eye gaze information and/or click stream information, for example. The user attention data may be captured for the content across a plurality of users, for example. The user attention data is used to generate a mapping of the user attention data to locations in the content and corresponding segments of the content at those locations (step 440). For example, a heat map may be generated that identifies user attention at locations of the content. For each segment of the content, a user attention score is determined based on the mapping (step 450). The segments of the content are then labeled based on the location, content type, user attention score, and the like, to generate labeled training data (step 460). The operation then terminates.

While the flowchart shows the operation terminating, it should be appreciated that this process may be repeated for a plurality of different content and across a plurality of different users. Where the training data is captured across a plurality of different users, the user attention score may represent the user attention directed to the segments of the content accumulated across the plurality of users. Where the training data is captured for a particular user, the captured user attention data may be performed for a single user but with regard to a plurality of different content.

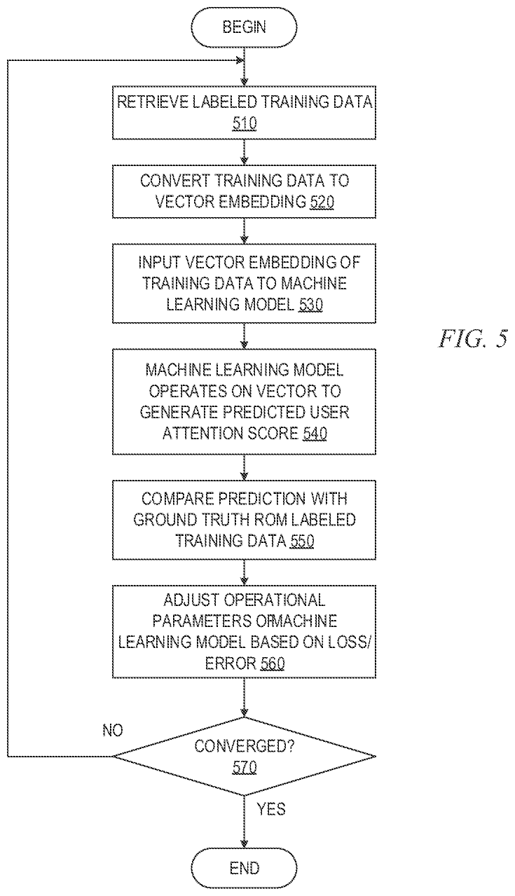

FIG. 5 is a flowchart outlining an example operation for training a machine learning computer model and deploying the trained machine learning computer model in accordance with one illustrative embodiment. As shown in FIG. 5, the labeled training data is retrieved for training the machine learning computer model (step 510). The labeled training data is converted to a vector encoding, such as using a BERT embedding or the like, for textual content (step 520). The vector embeddings of the training data are input to the machine learning computer model (step 530). The machine learning model operates on the vector representation of the training data to generate a predicted user attention score (step 540). The predicted user attention score is compared to the ground truth user attention score specified in the labeled training data to determine an error or loss (step 550). Operational parameters of the machine learning computer model, e.g., weights of nodes, are adjusted based on the determined error or loss, via a machine learning training operation, such as a linear regression, deep-regression, or the like, to minimize the loss or error (step 560). A determination is made as to whether the machine learning training has converged, where convergence is indicated by the loss or error being equal to or less than a predetermined threshold loss/error, or a predetermined number of iterations or epochs of machine learning training having been executed (step 570). If the training has not converted, the operation returns to step 510 and continues to perform the machine learning training operation with regard to additional training data. Otherwise, the operation terminates.

FIG. 6 is a flowchart outlining an example operation for generating a textual summary with expansion element insertion based on a trained machine learning computer model operation in accordance with one illustrative embodiment. As shown in FIG. 6, the operation starts by receiving new content (step 610). The new content is segmented and encoded (step 620) such that features of the segments of the new content are input to the trained machine learning computer model(s) (step 630). The machine learning computer model(s) generate user attention scores for each segment of the new content (step 640). The user attention scores and other factors, such as user profile information, content type information, content provider suggested or preferred expansion element location information, and the like, are used to generate final scores for each segment of content (step 650). The segments of content are then ranked and sorted based on their scores (step 660). A top K number of segments of content are selected for rendering, where K may be based on display space constraints, for example (e.g., if the given display space can accommodate 5 sentences, then K may be set to 5) (step 670). The selected segments are rendered in the output of the content while other segments are compacted and expansion elements, e.g., “see more” tags, are inserted in the locations of the compacted segments (step 680). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for rendering content in a compacted view, the method comprising:
training, through a machine learning process, a machine learning computer model to predict a user attention score for segments of content based on features of the content and historical user attention data;
processing, by the trained machine learning computer model, new content to associate with each segment, in a plurality of segments, of the new content, a corresponding user attention score;
ranking the segments, in the plurality of segments, of the new content relative to one another based on the corresponding user attention scores of the segments; and
rendering a compacted view of the new content on a client computing system based on the ranking of the segments, wherein a first number of segments are rendered in the compacted view and a second number of segments are not rendered in the compacted view and are replaced with an inserted user selectable expansion element.

2. The method of claim 1, wherein the machine learning computer model is trained on training data comprising historical user attention data for a plurality of users and a plurality of content, wherein the machine learning computer model identifies patterns in the historical user attention data for a portion of content, and predicts a user attention score for segments of the portion of content based on the identified patterns.

3. The method of claim 2, wherein the machine learning computer model is further re-trained to tailor the machine learning computer model operations to a particular user's historical user attention behavior based on historical user attention data of the particular user.

4. The method of claim 2, wherein the historical user attention data comprises eye gaze data specifying where a user's eye focuses when viewing the content and user click stream data specifying where the user clicks on the content being viewed.

5. The method of claim 2, wherein the training data further comprises format data and layout data for the content, wherein features from the format data and layout data are correlated with features from the historical user attention data when training the machine learning computer model.

6. The method of claim 1, wherein rendering a compacted view of the new content on a client computing system based on the ranking of the segments comprises inserting the user selectable expansion element at a location in a segment of the new content where a user's gaze is not predicted to be present as much as other segments of the new content or where the user's click stream is not predicted to be present as much as other segments of the new content.

7. The method of claim 1, wherein ranking the segments, in the plurality of segments, of the new content relative to one another based on the corresponding user attention scores of the segments further comprises evaluating user specified preferences in a user profile, in combination with the user attention scores to generate modified rankings of the segments, wherein the user specified preferences indicate types of content that the user prefers to view in their entirety or types of content that the user prefers not to view in their entirety.

8. The method of claim 1, wherein the new content is a virtual object in a virtual reality or augmented reality environment.

9. The method of claim 1, wherein the new content is a portion of textual content in a virtual reality or augmented reality environment.

10. The method of claim 1, wherein the second number of segments comprises a plurality of segments, and wherein rendering the compacted view of the new content on the client computing system comprises inserting a plurality of user selectable expansion elements, one for each of the segments in the second number of segments.

11. A computer program product comprising a computer readable storage medium having a computer readable program stored therein, wherein the computer readable program, when executed on a data processing system, causes the data processing system to:
train, through a machine learning process, a machine learning computer model to predict a user attention score for segments of content based on features of the content and historical user attention data;
process, by the trained machine learning computer model, new content to associate with each segment, in a plurality of segments, of the new content, a corresponding user attention score;
rank the segments, in the plurality of segments, of the new content relative to one another based on the corresponding user attention scores of the segments; and
render a compacted view of the new content on a client computing system based on the ranking of the segments, wherein a first number of segments are rendered in the compacted view and a second number of segments are not rendered in the compacted view and are replaced with an inserted user selectable expansion element.

12. The computer program product of claim 11, wherein the machine learning computer model is trained on training data comprising historical user attention data for a plurality of users and a plurality of content, wherein the machine learning computer model identifies patterns in the historical user attention data for a portion of content, and predicts a user attention score for segments of the portion of content based on the identified patterns.

13. The computer program product of claim 12, wherein the machine learning computer model is further re-trained to tailor the machine learning computer model operations to a particular user's historical user attention behavior based on historical user attention data of the particular user.

14. The computer program product of claim 12, wherein the historical user attention data comprises eye gaze data specifying where a user's eye focuses when viewing the content and user click stream data specifying where the user clicks on the content being viewed.

15. The computer program product of claim 12, wherein the training data further comprises format data and layout data for the content, wherein features from the format data and layout data are correlated with features from the historical user attention data when training the machine learning computer model.

16. The computer program product of claim 11, wherein rendering a compacted view of the new content on a client computing system based on the ranking of the segments comprises inserting the user selectable expansion element at a location in a segment of the new content where a user's gaze is not predicted to be present as much as other segments of the new content or where the user's click stream is not predicted to be present as much as other segments of the new content.

17. The computer program product of claim 11, wherein ranking the segments, in the plurality of segments, of the new content relative to one another based on the corresponding user attention scores of the segments further comprises evaluating user specified preferences in a user profile, in combination with the user attention scores to generate modified rankings of the segments, wherein the user specified preferences indicate types of content that the user prefers to view in their entirety or types of content that the user prefers not to view in their entirety.

18. The computer program product of claim 11, wherein the new content is a virtual object in a virtual reality or augmented reality environment.

19. The computer program product of claim 11, wherein the new content is a portion of textual content in a virtual reality or augmented reality environment.

20. An apparatus comprising:
at least one processor; and
at least one memory coupled to the at least one processor, wherein the at least one memory comprises instructions which, when executed by the at least one processor, cause the at least one processor to:
train, through a machine learning process, a machine learning computer model to predict a user attention score for segments of content based on features of the content and historical user attention data;
process, by the trained machine learning computer model, new content to associate with each segment, in a plurality of segments, of the new content, a corresponding user attention score;
rank the segments, in the plurality of segments, of the new content relative to one another based on the corresponding user attention scores of the segments; and
render a compacted view of the new content on a client computing system based on the ranking of the segments, wherein a first number of segments are rendered in the compacted view and a second number of segments are not rendered in the compacted view and are replaced with an inserted user selectable expansion element.
